(19) United States
(12) Patent Application Publication
(10) Pub. No.: US 2014/0041285 A1
(43) Pub. Date: Feb. 13, 2014

(54) PEST CONTROL MATERIALS

(71) Applicants: Stephen John Russell, Harrogate (GB); John Bruce Alexander, Lothian (GB)

(72) Inventors: Stephen John Russell, Harrogate (GB); John Bruce Alexander, Lothian (GB)

(73) Assignee: INSECTSHIELD LIMITED, Leeds, Yorkshire (GB)

(21) Appl. No.: 13/979,669

(22) PCT Filed: Jan. 13, 2012
(86) PCT No.: PCT/EP2012/050532

§ 371 Date: Oct. 8, 2013

(30) Foreign Application Priority Data
Jan. 14, 2011 (GB) 1100621.0

(51) Int. Cl. A01M 29/34

(52) U.S. Cl. CPC A01M 29/34
USPC 43/132.1; 428/95; 428/90; 28/143

(57) ABSTRACT

An open mesh insect control material is described which includes an insect contact surface, an internal surface, apertures communicating both surfaces and a plurality of filamentous projections protruding from the insect contact surface the projections at least partly occlude the apertures. The structure is suitable for use in pest control especially as a mosquito net.

### FIELD OF INVENTION

This present invention relates to novel materials and to methods of their manufacture. In particular, the present invention provides a pest control material that provides physical protection against insects as well as providing insecticidal functionality; and to methods of preparation of such a material.

### BACKGROUND TO THE INVENTION

Mosquito nets and crop protection nets both act by providing a physical barrier to insects. The former are designed to protect people or animals sleeping under them from the bites of haematophagous insects such as mosquitoes, phlebotomine sand flies, simuliid black flies, horse flies and midges and thus preventing transmission of the pathogens causing diseases such as malaria and leishmaniasis. More recent developments involve treating the mesh with conventional insecticides (especially pyrethroids) by impregnation of the fibres, or by incorporating these chemicals into the polymer material of the yarn, which then diffuses over the net surfaces. This prolongs insecticidal activity of the net and reduces the risks to handlers involved in the treatment or re-impregnation processes. Haematophagous insects such as mosquitoes are attracted on to the treated surface by carbon dioxide and other stimuli emitted by the person sleeping under the net, which therefore acts as a “baited trap”. On making contact with the treated mesh they are deterred from probing by the excito-repellent properties of the insecticide and may die rapidly as a result of its neurotoxicity. Crop netting acts by providing a purely physical barrier to insect pests of plants and the same principle has been applied to protection of cut timber from beetles and other pests.

The physical barrier to a particular insect pest is dependent on the choice of mesh size of the net, specifically the dimensions of the holes/apertures in the net and the open area. The average aperture size in an insecticidal mosquito net is typically 1.4 mm²-6.5 mm² with open areas of about 30%-75% depending on the net manufacturer. Fabric area densities are normally less than 100 g m⁻² and typically 30-50 g m⁻².

The aperture size of a mesh is dependent on the number of yarns per inch and the yarn diameter. To prevent passage of mosquitoes, the mesh size of a conventional mosquito net is approximately 1.15 mm-2 mm wide (assuming substantially square holes in the net). Nets are made with approximately 120-256 apertures per inch².

World Health Organisation (WHO) specifications for netting materials and mosquito nets have indicated that the average number of complete apertures should be not less than 156 per inch² with the lowest value not less than 148 per inch².

A hole or aperture size of about 1.15 mm diameter generally stops penetration of mosquitoes, but a smaller aperture size may be required to block smaller insects, such as phlebotomine sand flies, the vectors of Leishmania. Since sand flies are much smaller than mosquitoes a mesh size of about 0.6 mm diameter or less is required. Nets intended to physically prevent the penetration of the smallest insect pests can have more than 580 apertures per inch². However, with all mesh sizes and many types of insect, these insects may still be able to force all or parts of their bloodsucking mouthparts across the mesh, particularly if the occupant of the net has some part of the body in contact with it.

U.S. Pat. No. 5,600,850 describes a garment for protection against insects comprising an inner layer of material onto which an outer layer of mesh is placed. The inner layer is formed having a plurality of arches to elevate the outer mesh layer a distance from the user's skin. The outer mesh layer is impervious to insects while the distance defined by the arches prevents the insect's stinger or proboscis from reaching the skin. In an alternative embodiment, the inner layer is also made of mesh with a series of heat shrinkable polymeric strands running therethrough which are heat-treated to cause the inner layer to form a series of arches.

Published German Patent Application No. DE10241024, describes a garment which consists of a top layer, e.g. a net fabric, and a spacer fabric. The top fabric prevents an insect from getting through and the spacer fabric is thicker than the length or penetration depth of the stinging and/or biting organ of an insect.

Published United States Patent Application No. 2002/0124293 describes lower body, upper body, and hood garments formed of a textile that inhibits the ability of insects or small animals to bite or sting the wearer. The textile of the garments have a base fabric and a cover fabric separated by a spacer layer. The base fabric is open to facilitate breathability. The cover fabric is sufficiently closed to inhibit insects, spiders, or other small animals from passing through the cover fabric, and sufficiently open so as not to inhibit the breathability of the textile. The spacer layer separates the base fabric from the cover fabric with sufficient distance to inhibit insects, spiders, or other small animals from probing through the textile to reach the wearer.

International Patent Application No. WO 2008/001044 describes a pest control material comprising a textile yarn, filament or thread, e.g. in the form of a net, having a surface with irregular micro-projections wherein the micro-projections comprise an abrasive and/or an absorptive material such as diatomaceous earth (DE), which can also absorb wax from the outermost layers of insect exocuticle and produce death by desiccation. The micro-projections may be of particles which may range in size from 5 μm upwards.

### DISCLOSURE OF THE INVENTION

We have now found a novel form of material especially for use as mosquito or crop nets among other uses.

Thus, according to the present invention there is provided an open mesh material comprising a contact surface, an internal surface, apertures communicating both surfaces and a plurality of filamentous projections protruding from the contact surface and wherein projections at least partly occlude the apertures. The open mesh material is preferably a pest control material.

According to a further aspect of the present invention there is provided a control material in the form of an open mesh structure, having a surface with multiple filamentous projections protruding in one or more different orientation directions. The open mesh material is preferably a pest control material.

In the present invention, there is provided a material formed as an open mesh for example as a net, which is generally planar having an insect contact surface on one side of the mesh and an internal contact surface on the other side of the mesh, both sides in communication with each other via a plurality of apertures of a predetermined size. By open mesh is meant a mesh like material having apertures with area dimensions of 0.5 mm² or more, which is in contrast to a closed, tightly knitted mesh of a conventional knitted fabric. The material is intended to resist penetration by insects of all types, having a predetermined frontal cross-sectional size. The term “frontal cross-sectional size” is used herein to indicate the size (generally represented as an area) presented by a representative insect of a target species as it moves to penetrate an aperture of the material typically in a head-forward direction. Unlike prior art materials which act by keeping the aperture size to a value less than the frontal cross-sectional size of the insect, the present material is characterized in one embodiment by the apertures being formed to have a size theoretically large enough to permit the passage of the insect. However, a plurality of filamentous projections extend away from the generally planar contact surface to at least partially occlude access to the apertures, such that the projections are effective to block the passage of the insect in spite of the apertures being large enough to otherwise allow it to pass through. In one embodiment the filamentous projections may extend away from all surfaces of the open mesh structure. In this embodiment in addition to the filamentous projections extending away from the contact surface they may also extend away from the internal surface of the open mesh structure and/or surfaces within the apertures of the open mesh structure.

The insect contact surface is the surface of the material upon which the insect will land or attempt to land and as such is also referred to as a land or landing area of the material.

In accordance with another embodiment of the present invention, there is provided a material intended to resist penetration by various types of insects. The material of the invention is especially suitable for use as, inter alfa, a pest control material.

When designing a material to restrict passage of insects, it is known to control the aperture size of the material. More effective blockage of insects can be obtained with a smaller aperture size; however, a smaller aperture size also results in a material that may be undesirably more expensive and more restrictive to the circulation of air. The surface-protruding projections in a material of the present invention allow for an open mesh or net material to be manufactured that allows effective air circulation when compared to prior art materials. As such, open mesh materials may be provided by the present invention to have aperture sizes which are actually larger than commonly desired for a particular application, since the filamentous projections provide an apparent aperture size that is less than an actual size of the respective apertures. Because the surface projections provide very little resistance to the movement of air, the materials of the present invention have a substantially similar permeability to air when compared to the same material without the filamentous projections.

Thus, the material of the present invention comprises an open mesh or net layer provided with projections from the contact surface i.e. land areas, in the form of multiple filaments. The contact surface may or may not lie in the same plane as the apertures. The nature of many mesh like structures is such that they do not have distinct surfaces as they are often made of fibre based materials sometimes assembled into yarns, which form the fabric, presenting a plurality of surfaces many of which are in communication with each other. In the context of the present invention reference to a contact surface or inner surface denotes the functional distinction between the two sides of the mesh. One side, namely the inner side or surface, presents itself to an area which is to be isolated from contact with insects. The other side, namely the contact side or contact surface, presents itself to the exterior areas populated with insects. It can be considered that the open mesh material is substantially planar and that the contact surface and internal surfaces of the mesh are either sides of the plane of the mesh.

The filamentous projections can be considered as having proximal and distal ends and ideally, the length of each filament projection is such that its distal end terminates at a height above that of the plane of the open mesh or net layer. However, the filamentous projections are firmly connected at their proximal ends to the underlying open mesh material and are oriented out of the plane of the open mesh material, i.e. the x-y plane of the open mesh material. The filaments are generally flexible, such that the filament along its length may present a variety of orientations to the plane of the mesh material. Thus a fraction of each filament projection, e.g. the distal end or tip may be oriented transversely relative to the x-y plane or even horizontal to that plane. Thus, only a proportion of each filamentous projection typically the proximal end is substantially perpendicular to the plane of the open mesh fabric. Thus the orientation of the individual filamentous projections can be represented by a distribution of projection angles wherein the filaments are oriented at angles of >0 degrees and ≦90 degrees relative to the plane of the open mesh or net material. The height that each filament projection extends above the surface of the open mesh or net material can also vary substantially. When viewed from above, i.e. a plan view of the open mesh, the projecting filaments at least partly occlude and/or conceal the underlying apertures, i.e. mesh openings, because of their relative orientations with respect to the open mesh material. This has the effect of reducing the apparent or effective open area of the mesh (i.e. the area represented by the apertures) when viewed from above, i.e. in plan view of the open mesh material, to <30%, preferably <25%, more preferably less than 20% and most preferably <10% of the surface area of the fabric, without any appreciable change in the air permeability, mesh fabric density and/or porosity of the overall structure of the open mesh, compared to a conventionally known insect control net material. In various embodiments, the projections may reduce the apparent open area of the open mesh material when viewed from above to less than 80% or less than 60% or less than 40% of the actual open area of the open mesh material when viewed from above without the projections. Further, in various embodiments, the projections may reduce the apparent average size of the apertures (expressed in area) to less than half of the actual average size of the apertures when viewed from above, or to less than 40% or less than 25% of the actual average size. One will appreciate that an insect approaching the material from above and attempting to land on the insect contact surface would have to navigate through a tortuous path of projections that present openings reduced to the apparent size of the apertures before gaining access to the actual apertures.

It should also be appreciated that with the open mesh structure of the present invention there is a large contact area on the insect as a result of the projections, which serves to mechanically interfere with multiple parts of the insect's anatomy (thoraz, legs, palps, etc.) The large contact area and the repeated contact that is introduced by the movement of the insect relative to the filaments provides a means of desiccating or disrupting the surface of its cuticle.

The angle of orientation of the plurality of filamentous projections relative to the plane of the open mesh may be randomized. When viewed from above, the filamentous projections may extend from the contact surface of the open mesh material to project over the respective apertures at different angles of orientation, and when viewed from the side (parallel to the open mesh surface), they extend at different angles relative to the plane of the open mesh material, such that all filamentous projections are not oriented in a particular direction. In this way, the apparent open area viewed from above, as would be presented to a penetrating insect, may be further decreased by the random projection orientations.

The projections may generally have an angle of orientation less than 90 degrees relative to the plane of the open mesh material, although some projections standing straight up at 90 degrees to the open mesh surface may also increase the effectiveness of the material by engaging an incoming insect at a maximum distance above the surface of the material.

In the manufacturing of the material, the orientation of the filamentous projections may be controlled if desired by the application of heat, pressure, and/or the addition of suitable materials, (e.g., adhesives, drying agents, solidifying agents or the like).

The presence of the filamentous projections from the surface of the open mesh material enable the apertures to be larger than in a conventional mosquito net whilst still providing satisfactory physical protection against insect penetration. This allows the open mesh material to have both a larger hole or aperture size than would otherwise be suitable for preventing the physical penetration of small insects using an existing insect control net whilst retaining a relatively light weight (e.g. from about 50 to 375 g m⁻²) and excellent air permeability e.g. flow rate of >6 m/s @100 Pa for a fabric of 150 g m⁻².

The aperture size in the open mesh material of the present invention may be from about 0.5 up to 12 mm², preferably from about 0.5 to 8 mm², more preferably from about 1 to 6 mm² more preferably 1 to 4 mm, more preferably 1.5 to 2 mm, and most preferably 1.75 to 2 mm. These aperture sizes are the aperture sizes of the untreated open mesh material and the aperture sizes in the treated mesh (e.g. with a diatomaceous earth and/or an adhesive coating) will be slightly reduced due to the applied coating thickens. Additionally, the greater apparent thickness of the open mesh structure (due to the projecting filaments) increases the distance through which an insect is forced to probe to enable the end of its proboscis to reach the reverse side of the fabric and contact the host. When used as a pest control material this enhances the physical protection that is afforded by the fabric to proboscis penetration. Furthermore, the variations in filament projection angles and the subdivision of the underlying open mesh structure in to smaller pores (when viewed from above), as well as the point of contact with the distal ends of the filament projections and the tangential contact of the insect with the sides of the filament projections, maximises physical contact between the insect and the filament projections. This contributes to repeated mechanical disruption of the insect as it moves relative to the solid surfaces of the open mesh material and the filamentous projections. This has an important effect on insects trying to penetrate the open mesh structure of the present invention. The first function of the open mesh structure of the present invention is to provide a physical barrier to the insects trying to reach a human subject or a crop material. The second function is to increase disability and change the insect's behavior e.g. to inhibit blood feeding, direct mortality and disease related mortality within the relevant insect population. This is referred to as the residual effect. The nature of the open mesh structure of the present invention is such that it not only achieves the primary function required but in addition leads to significant increases in disability and direct mortality or disease related mortality in these insects, namely the residual effect. This is also referred to as the insecticidal effect.

By the term relatively light-weight is meant, for example, from about 50 to 375 g m⁻², preferably from about 100 to 300 g m⁻², more preferably from about 150 to 250 g m⁻², most preferably from about 175 to 225 g m⁻².

By the term excellent air permeability is meant, for example, an air flow rate of >6 m/s @100 Pa, preferably >5 m/s @100 Pa, more preferably >4 m/s @100 Pa, most preferably >3 m/s @100 Pa, and preferably for a fabric of 150 g m⁻².

In various exemplary embodiments of the present invention, where the open mesh material is used as an insecticidal material, the apertures of the material may have a size which is at least 20% larger by area than a predetermined frontal cross-sectional size of a target insect, or at least 50% larger, or at least twice as large by area as the predetermined frontal cross-sectional size of the insect.

Thus, the material according to the invention is useful as an insect barrier and insecticidal barrier. Insecticidal functionality may be further improved or maximised by coating all or part (e.g. the sides and/or the tips) of the filamentous projections and/or the open mesh sub-structure using a chemical pesticidal composition as hereinafter described. Such a pesticidal composition may be, for example, an abrasive and/or desiccating material, e.g. a desiccating inorganic material, such as diatomaceous earth, i.e. that disclosed in International Patent Application No. WO 2008/001044. It may also be another silicaceous material (such as plant opals, silica gels), clays or an organic material, such as polycarbonate. This insecticidal functionality is principally provided therefore from the coating that is applied to the filamentous projections and the mesh below. Thus, the net structure may provide a physical barrier by increasing the distance through which the insect has to probe to reach the target. As the insect probes in attempting to secure a blood meal or moves around on the surface trying to pass through the mesh its body parts are forced to make contact with the filament projections. Additionally the filaments make it more difficult for the insect to manoeuvre into such a position that would allow it to pass through the mesh or to orientate itself in order to attempt to feed. Physical contact between the insect and the net/projections/pesticide is therefore maximized and the surface produces both contact and physical resistance (or drag) on the movement of the insects' body parts. The multiple, closely spaced filament projections may also enable “trapping” of the insect, effectively immobilising it or resisting its movement and preventing its passage through the net.

The coatings as used in the present invention may be applied to the underlying open mesh structure with projections via spraying, dip coating or other suitable techniques. As an alternative method the coating formulation may be applied via lick coating of the formulation on to the filamentous projections; this provides a means of localising the coating to the projections (minimising coating of the mesh) or to the tips of the projections according to process conditions. This has the effect of reducing the overall coating weight applied to the material since the underlying mesh becomes substantially uncoated and free of the formulation. Note that the fabric may be pre-tensioned using a stenter or similar means during coating to increase the aperture size and reduce the effective area density. The new dimensions are then stabilised by heat setting during the subsequent drying and curing step, which normally takes place in a through-air (convection) oven.

In accordance with a further aspect of the present invention, the distal ends i.e. tips of the projections may have a diameter that is greater than that of the respective stems and/or proximal ends of the projections. The tips are located at the distal end of the projection remote from the surface of the open mesh material and the stems of these filaments extend to make contact with the surface of the open mesh material at the proximal end of the filament. The tips may be configured to have any desired shape. In one embodiment, the tips have a bulbous shape on the distal ends of the respective projections. The bulbous shape may be relatively spherical or tear-drop shaped. In one embodiment, the tips have a relatively beaded appearance that aid in occluding access to the apertures of the material. To form the bulbous tips, a coating may be applied to the projections by dipping, spraying, or the like. The tips may also be barbed or recurved to make them more effective in impeding the progress of the insect. The coating may include an insecticidal material as described above or may be any suitable material, such as an adhesive, which may form solid tips with or without heat treatment or drying.

The density of holes or apertures in the mesh or net fabric may vary and may be from about 50-1600 holes/inch², preferably from about 100 to 1300 holes/inch², more preferably from about 120 to 1000 holes/inch², more preferably from about 120 to 500 holes/inch², more preferably from about 120 to 400 holes/inch², more preferably from about 120 to 350 holes/inch², and most preferably from about 120 to 200 holes/inch², especially about 150 to 160 holes/inch², ideally 156 holes/inch².

The shape of the apertures may be any conventionally used in the art of pest control materials, thus the mesh may comprise a square-mesh, a triangular-mesh, a rhomboid-mesh, a hexagonal-mesh, or a rectangular-mesh or combinations thereof. The holes or apertures may be arranged in a generally random manner. However, preferably the apertures may be arranged in a patterned arrangement, e.g. in a substantially periodic or patterned manner.

The filamentous projections extend from the surface of the open mesh structure and this extension increases the apparent thickness of the open mesh structure. Thus, the length of the projections may be from 1.0 mm to 15 mm, preferably from 1.5 mm to 10 mm, more preferably from 2 mm to 8 mm, most preferably from 2.5 mm to 7 mm. These three dimensional projections as described above are generally non-rigid, that is they have a degree of flexibility. However, these three-dimensional filamentous projections are sufficiently stiff to stand proud of the plane and contact surface of the underlying open net structure and also are sufficiently flexible or resilient to recover their position following compressive forces or shear. The term “standing proud” means that the projections have adequate stiffness to support their own weight such that only one end, the proximal end, of the projection is in contact with the mesh surface. A linear projection that is standing proud will have one end, the proximal end, attached to the surface of the open mesh material and one end, the distal end, extended above that surface. The flexibility or resilience may be due to the dimensions of three-dimensional projections, e.g. length, diameter, aspect ratio, etc., or the nature of the material which comprises these three dimensional projections. This increase in apparent thickness of the material provides additional functionality when the material is used as a mosquito net, since the insect is physically held somewhat above the planar surface of the open mesh, and thus farther away from the underlying skin of its intended bite victim. The mosquito or other bloodsucking insect is thus frustrated in its attempt to extend its proboscis into the skin through the aperture. The use of the filamentous projections of the present invention to achieve this effect is beneficial compared to more complicated and expensive alternatives used in the art. The present invention provides this effect in a single layered structure, which may be lighter and more permeable than other methods in the art.

The number of filamentous projections may vary depending upon, inter alia, the size of the apertures i.e. holes, the desired weight of the insect net, the target insect, etc. Desirably, the population density of the filamentous projections is from 20 to 150 per cm², preferably from 30 to 140 per cm², more preferably from 40 to 130 per cm², more preferably from 50 to 120 per cm², more preferably from 60 to 110 per cm², more preferably from 70 to 100 per cm², more preferably from 80 to 90 per cm².

This flexibility or resilience enables the three-dimensional projections to partially occlude the apertures in the underlying mesh structure due to, inter alia, their frequency, length/aspect ratio, tip shape and orientation relative to the underlying net surface, e.g. when viewed from above. For the avoidance of doubt, the term “aspect ratio” used herein means the ratio of the longitudinal dimension of each of the projections to its shorter dimension, e.g. the ratio of the longest vs. shortest axes, or the ratio of the length vs. diameter of projections. The length:diameter ratio of the projections is preferably from about 3 to 150, more preferably from about 6 to 110 and most preferably from about 8 to 80. In various embodiments, the filamentous projections may have a length of approximately 1.5-20 mm, preferably 2-10 mm, more preferably 3 to 10, more preferably 3 to 9 mm, more preferably 4 to 8 mm and most preferably 5 to 6 mm.

In addition, the filamentous projections from the underlying open mesh structure also increase the apparent or perceived overall thickness of the structure to values of from about 2 to 20 mm (compared to a conventionally known net fabric of thicknesses of about 0.1-0.3 mm). The perceived overall thickness is preferably from about 2 to 10 mm, more preferably from about 3 to 9 mm, more preferably from about 4 to 8 mm, most preferably from about 5 to 6 mm. The apparent or perceived overall thickness depends on, inter alfa, the length of the filamentous projections and the projection angle from the underlying open mesh layer. Variations in the relative orientation of the individual filamentous projections may also result in the crossing, physical contact and/or interference between adjacent filamentous projections adjacent or above the mesh openings. When viewed from above (plan view) the crossing, physical contact and/or interference between adjacent filamentous projections adjacent or above the open mesh net layer sub-divides the underlying hole/aperture sizes into much smaller pore openings whose largest dimensions may be perceived as, for example, <1 mm. As hereinbefore described, the filamentous projections are desirably flexible and/or resilient and may optionally be elastic. The filamentous projections are preferably resilient, i.e. they return to their original orientation after deflection and/or compression.

Filamentous projections whose resistance to compression and relative orientation can be pre-set, at least to some extent, e.g. by thermo-setting the structure (assuming thermoplastic polymer components, which is the normal case). The filamentous projections desirably have high resistance to compression to enable them to withstand repeated washing and/or abrasion during use.

The filamentous projections are connected at their proximal ends to the underlying open mesh structure. The projections typically comprise monofilaments, multifilaments, continuous or multi-filament yarns, short cut fibres, flocked fibres or hot melt extruded adhesive filaments raised from the surface or substantially embossed regions, or combinations thereof. In one preferred, embodiment the projections comprise continuous or multi-filament yarns that are firmly engaged with the open mesh structure and ideally are entwined within the fabric of the open mesh material.

In a further preferred embodiment the filamentous projections are bonded at or, proximate to; their proximal ends to a contact surface on the open mesh structure. In one embodiment the filamentous projections may be bonded to the insect contact surface, the internal surface and the aperture surfaces of the open mesh structure e.g. as with filamentous projections applied to such open mesh structures via for example flocking techniques. In this embodiment the filamentous projections may therefore be flocked filamentous projections.

Where a flocking process is used this typically involves the application of cut or ground fibres to a pre-formed open mesh or net fabric were the yarn surfaces of the fabric have been coated with an adhesive. Various flocking processes may be applied including electrostatic flocking. Surprisingly, it has been discovered that when flock filaments are applied to open mesh structures, the flock filaments project from the yarn surfaces of the open mesh fabric not just from the contact and internal surfaces of the structure but also across the aperture from the aperture surfaces (increasing aperture occlusion). In the current process, the adhesive is applied not just to the outer surfaces of the yarn (the in-plane direction) but also to the surfaces within the fabric cross-section (through the open mesh thickness) such that flocked filaments are deposited throughout the open mesh structure in addition to the contact and internal planar surfaces. The adhesives may be selected from acrylic, epoxy, polyvinyl acetate, polyvinyl chloride, plastisols, styrene butadiene, butadiene acrylonitrile, polyurethane and others that are preferably slow to “skin”. This coating may also include the diatomaceous earth and the like as herein described. The diatomaceous earth coating may be pre-applied to flock filaments or coated post flocking by spraying, lick roller, or any other coating or application means. Loose diatomaceous earth may also be applied with short cut fibres during flocking to the open mesh structure that has been pre-coated with an adhesive. Suitable fibres for flocking include; polyamides e.g. Nylon, polyacrylamide, polyesters e.g. PET, polyethylene, polypropylene, co-polyesters, cotton, viscose or mixtures thereof. These fibres as short cut fibres may be pre-coated with adhesive with diatomaceous earth and dried.

Preferably, depending upon, inter alia, the nature of the material comprising the filamentous projections, etc., the stiffness, orientation, frequency and/or proximity of the filamentous projections may facilitate direct mechanical interaction and abrasion with the exocuticle and other parts of the insect when it lands on the open mesh structure of the present invention, when it moves around on the structure or when it probes it. The extremities of the projections, i.e. the exposed distal tips and side edges of the filamentous projections, are presented directly to the incoming insect, such that there is direct interaction between the extremities of the projections and the insect (including the antennae, legs, thorax and mouthparts e.g. the palps or hypopharynx). The exocuticle abrasion can allow dehydration of the insect or ingress of pathogens, each of which can lead to deterioration of the condition, and eventual death, of the insect. Additionally, the multiple frictional contact points between the legs of the insect when it is contact with the net is such that the insect can be partly impeded from walking across the net; in some cases causing damage to the insect that restricts its ability to probe and feed. Furthermore by detaining the insect in a fruitless attempt to gain a bloodmeal, the filamentous surface of the structure of the present invention causes it to expend valuable time and energy which would be better spent on an unprotected host. These effects are the aforementioned insecticidal activity of the structure of the present invention.

When the material is for use as a pest control material the filamentous projections or a proportion of the filamentous projections may as hereinbefore indicated may comprise a coating of an insecticidal material. The insecticidal material may comprise an organic pesticide, an abrasive material or a desiccating material, such as, diatomaceous earth (DE), or combinations thereof. The insecticidal material may be adhered to the filamentous projections and/or the open mesh structure by use of a binder or an adhesive. In one embodiment, the filamentous projections are coated with an insecticidal material in the form of an adhesive having abrasive material protruding from a surface of the coating. The adhesive may be any suitable adhesive known in the art such as an acrylic adhesive, epoxy, latex, or the like including thermoplastic and thermoset adhesives. Desirably, the insecticidal material and optionally the adhesive, is resistant to washing, UV exposure and normal agencies of wear. Alternatively, the insecticidal material may be affixed to the open mesh and/or filamentous projections after coating with the binder or adhesive by one or more processes, including, inter alia, blowing, dusting or particle deposition processes known in the art. However, in use, it is intended that there will be repeated physical interaction between the insect and the pest control net of the present invention. For example, the insect may return multiple times in an attempt to take a blood meal during which time it may repeatedly probe the net. During this process, mechanical interaction between the solid surfaces of the filaments, the open mesh net layer and the insecticidal material, e.g. the insecticidal coating, are promoted. Normally, it is not intended for any insecticidal coating components to be transferred to the insect but microscopic transfer of desiccating materials from the net surface to the insect can be advantageous in bringing about death of the insect. Since most of the coating remains affixed to the net there is less risk of the user inhaling microparticles of desiccant; furthermore the coating will not be significantly removed and insecticidal contact diminished by repeated contact with insects.

The insecticidal, desiccating or abrasive material may strongly adhered to the surfaces of the open mesh structure and/or its projections and is provided such that multiple layers of insecticidal, desiccating/abrasive material are available to replace any material which is abraded off during use. Where the active ingredient is applied to the open mesh structure, the filaments may provide protection against any abrasion that occurs during washing by overlying the treated surface.

The efficacy of the insecticidal material, e.g. insecticidal, desiccating or abrasive material, in the coating, may be dependent upon, inter alia, ensuring that the exposed surfaces of the material are not completely covered by the bonding/adhesive matrix. For example, when the insecticidal, desiccating or abrasive material is diatomaceous earth (DE), the pores of the material can be substantially cleared of any such occlusion by introducing a solvent, preferably a volatile solvent, such as N-methyl-2-pyrrolidone (NMP) in the coating formulation. After coating the open mesh structure of the present invention, the solvent is quickly flashed off during heating due to its volatility. During this process, the solvent is forced out from the coating and the DE, which serves to open up occluded pores in the DE, thereby exposing an increased area of the DE surface. A suitable procedure for clearing DE in this way has been adapted from U.S. Pat. No. 5,496,397, and corresponding to International Patent Application No. WO 94/15709.

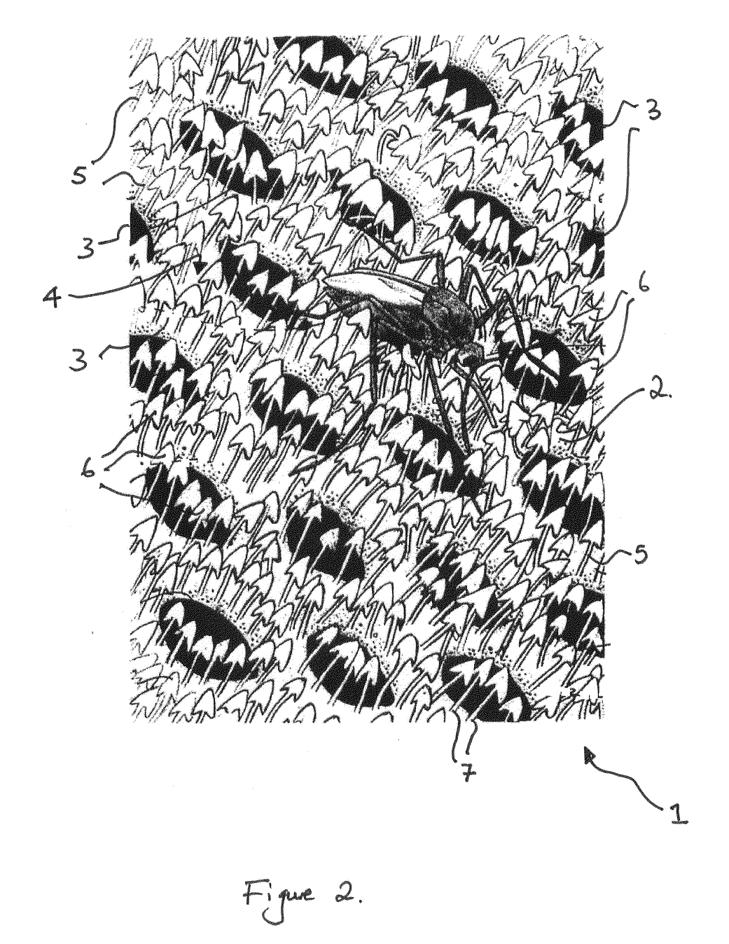

The filamentous projections may comprise substantially uniformly cylindrical filaments. However, in one embodiment, the tips of the filamentous projections may be modified so as to increase their diameter relative to the underlying stem of the filamentous projection (e.g. denoted as: mushroom tipped, see FIG. 2, hooked, barbed or otherwise modified) or to increase the possibility of insects making contact with the abrasive/absorptive surface and/or becoming trapped in the mesh, temporarily or permanently. This has the effect of further increasing the occlusion of the underlying open mesh structure without increasing the density of the filamentous projections or the fabric area density (weight per unit area).

The open mesh structure may be based on an open mesh material such as on warp and weft knitting (intermeshed structure), weaving (interlaced structure), knotting or plain net (twist lace) fabric production. In a preferred embodiment the mesh structure is produced by warp knitting. The open mesh material may be made from various materials including for example polyester, co-polyester, polyethylene, polypropylene, polyamide, viscose, or combinations thereof.

The preferred warp knitted fabrics, which are most suitable for use as the open mesh materials for making the open mesh structures of the present invention, are materials that are known as “openwork” fabrics. This term is used to differentiate tightly knitted warp knits from those that have large apertures and that are commonly described as “meshes” and “nets. These “openwork” fabrics are very distinct from other “pile” fabrics, which may be knitted or woven known in the art. These non-open fabrics are not suitable for use in the present invention because they cannot be considered as open meshes. Their base fabrics do not have the required apertures being too dense and the pile properties associated with these do not meet the requirements of the filamentous projections as used in the present invention. Typically, all knitted fabrics are produced by intermeshing yarns and these textile pile fabrics have either a knitted or a woven base from which projecting fibres are raised from their surfaces. Thus, these typical pile fabrics such as fur fabrics, velvets, sliver knit fabrics, tufted fabrics, terry fabrics, carpet fabrics, velours, loop and cut pile fabrics and the like are not suitable for use in the present invention, because of their density, thickness, heavy weight and very small aperture sizes.

One approach to the production of the open mesh structure of the present invention involves modification of the normal warp knitting fabric formation process in the following manner: a warp knitted spacer fabric comprised of two discrete mesh fabrics that are interconnected by crossing filaments is split between each fabric layer to produce two separate fabrics. After separation, filaments are firmly attached to and project from the surface of the open mesh structure. The orientation of the resulting projecting filaments can then be controlled to an extent by applying pressure and heat. If produced from thermoplastic materials, such as PET, the configuration of the filament projections can be stabilised by heat-setting. Thus, it is an aspect of the present invention to provide an open mesh material wherein the filamentous projections comprise one or more thermoplastic materials.

The slitting of the spacer fabric takes place in-plane; for example down the centre of the mesh fabric. i.e. to create two separate fabrics of ca. 5 mm thickness. It will be understood that slitting may be offset from the centre so that two fabrics are produced each with different filament projection heights (as required). Slitting may be undertaken discontinuously or continuously by means of hot wire, oscillating blade, knives or other cutting means. Use of thermal slitting means enables the formation of “tipped” filament projections (if required) due to localised thermal shrinkage of the filament projections at their distal ends, wherein the distal ends of the projecting filaments become wider in diameter (bead shaped) as compared to the shank of the same projecting filaments. Similar effects may be produced by introducing contact of the distal ends of the projecting filaments with a pre-heated surface such as a calender roller that is set to operate at a temperature near to the melting point of the material. The material is introduced to this surface at very low pressure such that compression and flattening of the projecting filaments is minimised.

Thus, according to a further aspect of the present invention there is also provided a method of preparation of an open mesh insect control material comprising an insect contact surface, an internal surface, apertures communicating both surfaces and a plurality of filamentous projections protruding from the insect contact surface and wherein projections at least partly occlude the apertures; which method comprises slitting and separating a warp knitted spacer fabric comprised of two discrete mesh fabrics layers interconnected by crossing filaments longitudinally between each of the mesh fabric layers to produce two separate and discrete open mesh insect control materials.

Thus according to a further aspect of the present invention there is provided a method of preparation of an insect control material in the form of an open mesh structure, having a surface with multiple filamentous projections protruding in one or more different orientation directions which comprises slitting a warp knitted spacer fabric comprised of two discrete mesh fabrics layers interconnected by crossing filaments between each of the mesh fabric layers to produce two separate and discrete open mesh insect control materials.

After separation, filamentous projections protrude from the surface of the open mesh structures to form a three-dimensional pest control material.

In another embodiment, the filament projections may be added by flocking fibres to a base open mesh material such that filamentous projections extend from one or more of the planar surfaces of the open mesh material.

The method of the invention may include coating at least the tips of the projections with an insecticidal material. Such a coating may be applied by a variety of means including, inter alia, chemical dipping.

Additionally, treatments may then be applied to modify the tip of the projections such that the tip becomes thicker than the original diameter of the projection. This may be achieved by localised heat treatment of the tips of the projections or by chemical dipping—the effect is to produce a bulbous tip whose widest dimension may be 1.5-20× that of the original filament that forms the stem.

The present invention further provides open mesh materials as hereinbefore described for use as a pest control material.

The invention further provides the use of an open mesh material as hereinbefore described in the manufacture of a pest control material.

Although the incorporation of conventional chemical insecticides may optionally be used with the open mesh structures of the present invention, their absence does not prevent the open mesh structures of the present invention providing pest-control methods which kill and/or physically damage mosquitoes and other insect pests. It can be used in mosquito nets and other pest control devices and materials, including protective clothing, garden or crop netting and fleeces, protective bands for fruit trees, horse blankets, hairnets and filters for grain stores or flour mills.

It could thus also replace or enhance the performance of the following:

(a) Midge screens or veils which require a very fine mesh to be effective;
(b) Insect repellents containing diethyltoluamide (DEET), citronella or other chemical which are effective for a limited period and may have health problems associated with their long-term use;
(c) Garden or crop netting (e.g. crop cover) and fleeces where mesh size or pore size again needs to be very fine, excluding the pest species but restricting the circulation of light, heat and moisture;
(d) Chemical pesticides used against agricultural and horticultural pests (costly, detrimental to the environment and non-target organisms);
(e) Horse blankets that cause discomfort to animals because of their weight;
(f) Repellent sprays containing citronella and eucalyptus that have limited effectiveness and are disliked by horses;
(g) Sticky bands placed around trees to trap pests that climb the trunks;
(h) Anti-louse shampoos containing harmful insecticides;
(i) Fly screens that restrict air flow;
(j) Filters and window screens used in flour mills and grain stores;
(k) Insect electrocution devices;
(1) Slug control methods of all types including copper bands, rings, mats, baited traps that act by irritating the animals to such a degree that they do not attempt to cross the treated surface;
(m) Slug pellets, which contain active ingredients such as aluminium sulphate or chlorpyriphos;
(n) Covers to protect livestock from insect bites and to prevent downgrading of subsequent products due to defects (e.g. leather); and
(m) Window blinds, covers and screens in domestic and commercial buildings and transport to protect occupants

The invention further provides a method of pest control, which comprises substantially surrounding a potential host with an open mesh pest control material as hereinbefore described.

The invention will now be illustrated by way of example only and with reference to the accompanying drawings in which;

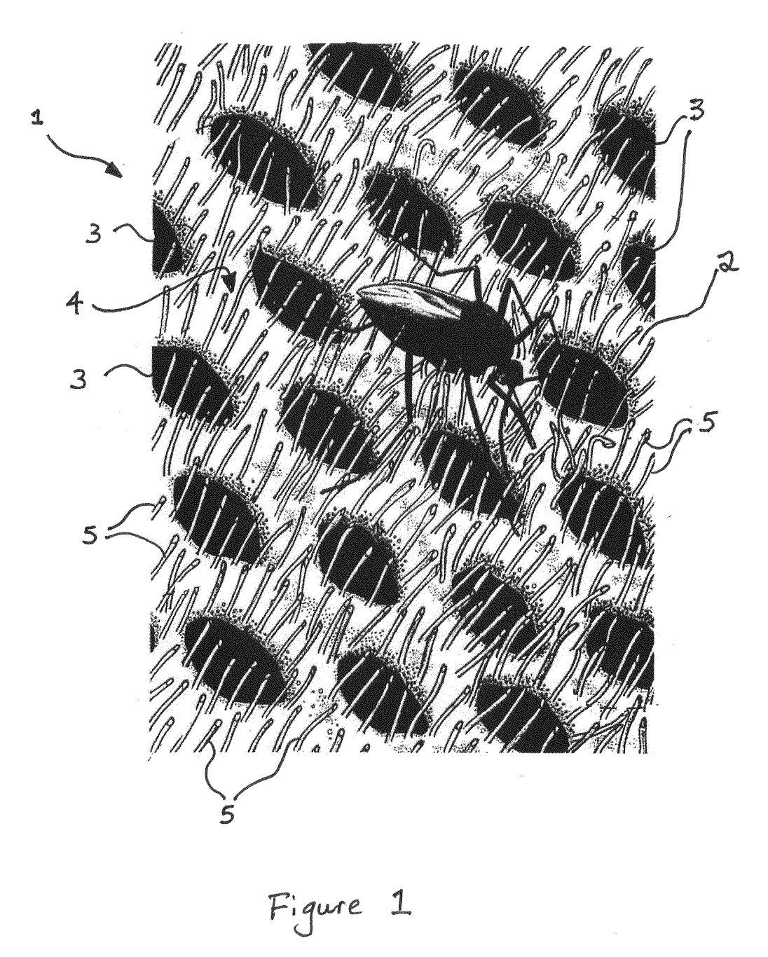

FIG. 1 is a perspective schematic view of an open mesh structure according to the present invention with monofilament projections;

FIG. 2 is a perspective schematic view of an open mesh structure according to the present invention with modified tip configurations;

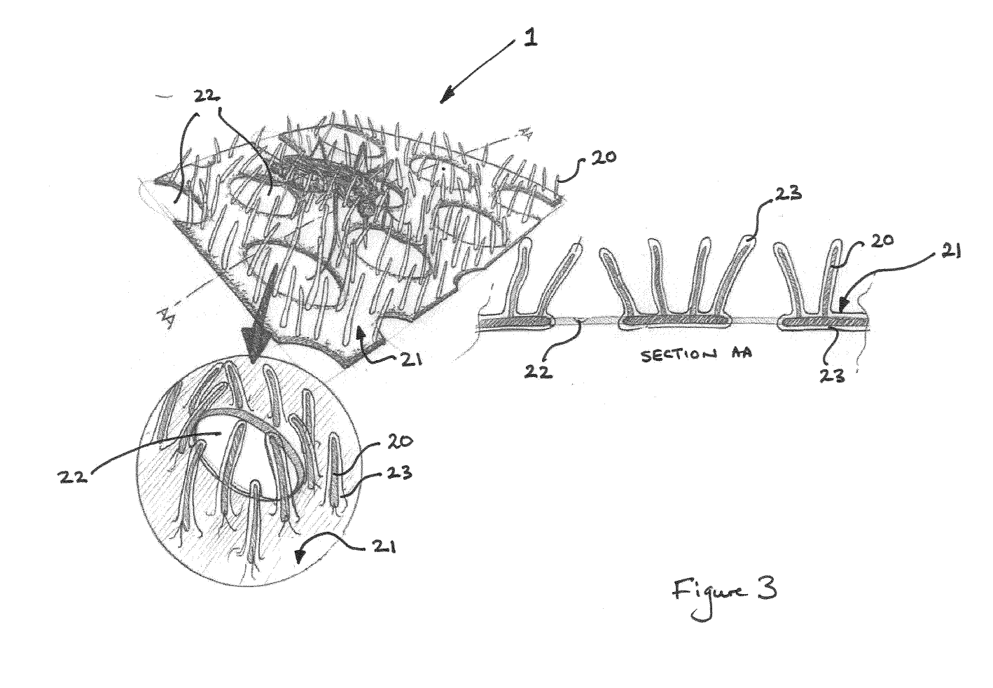

FIG. 3 is a perspective schematic view of an embodiment of the invention as seen from above;

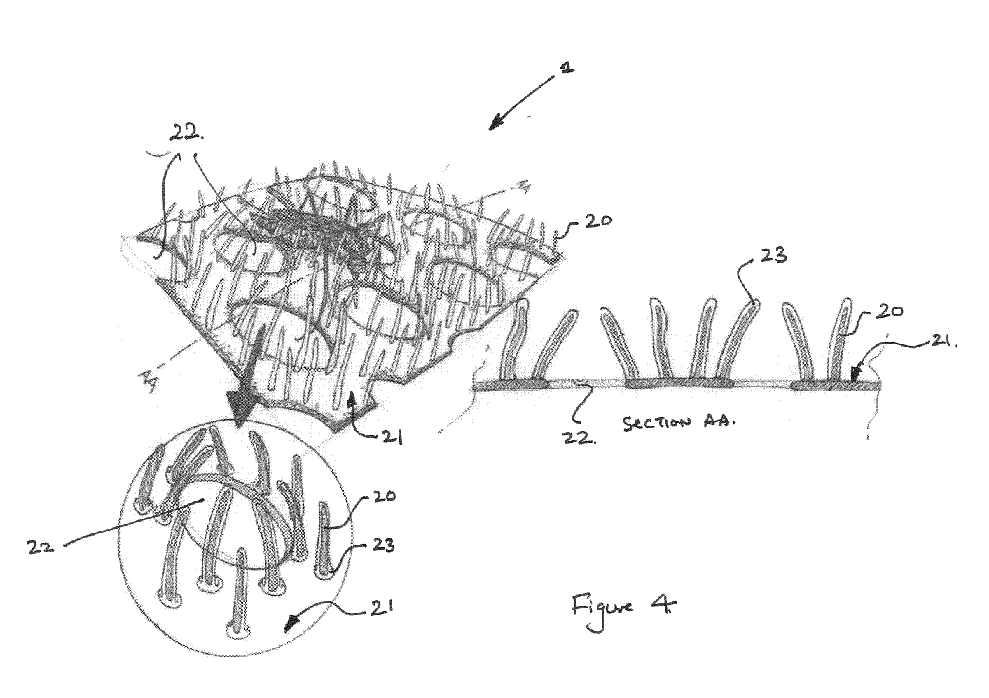

FIG. 4 is a perspective schematic view of an embodiment of the invention as seen from above;

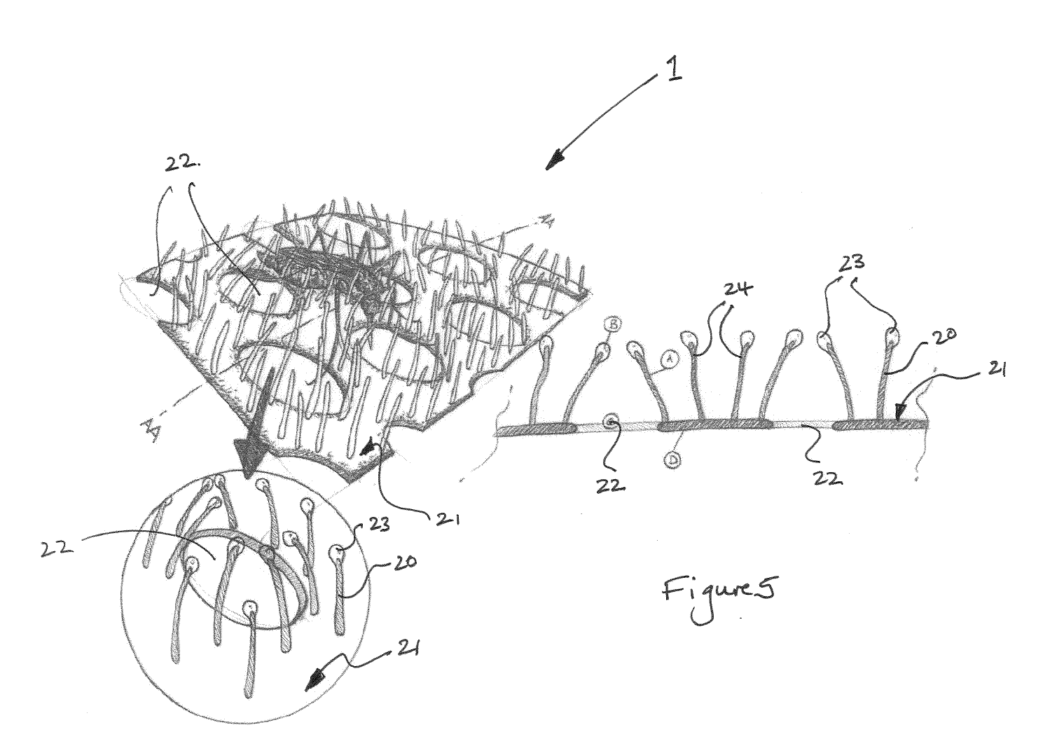

FIG. 5 is a perspective schematic view of an embodiment of the invention with a modified tip configuration;

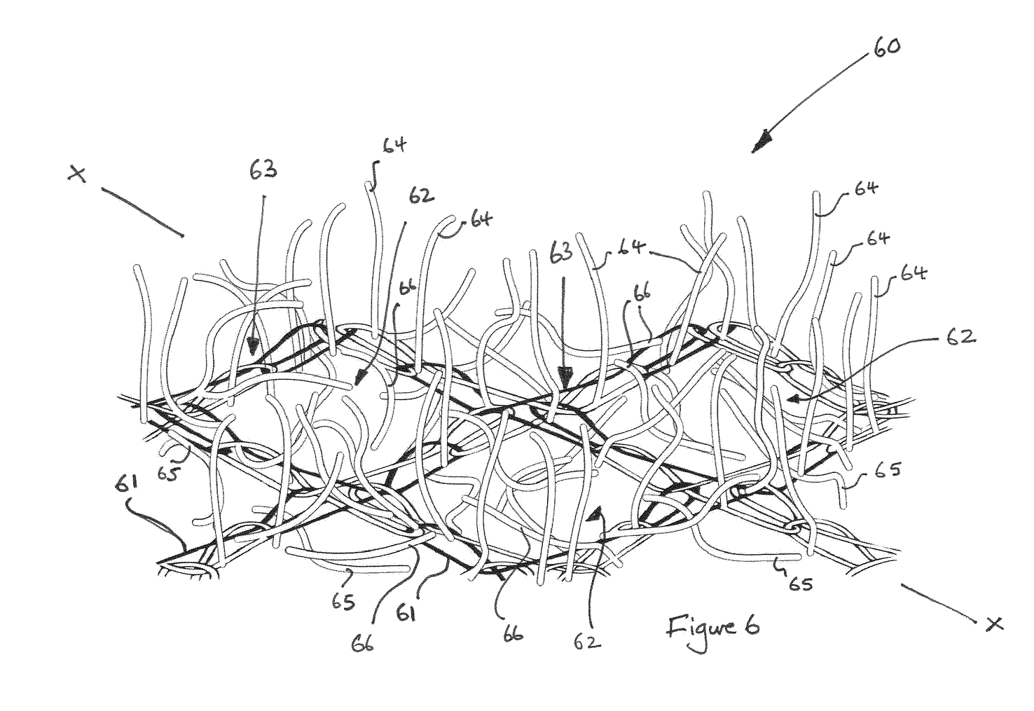

FIG. 6 is a perspective schematic view of an embodiment of the invention, which has been manufactured via flocking;

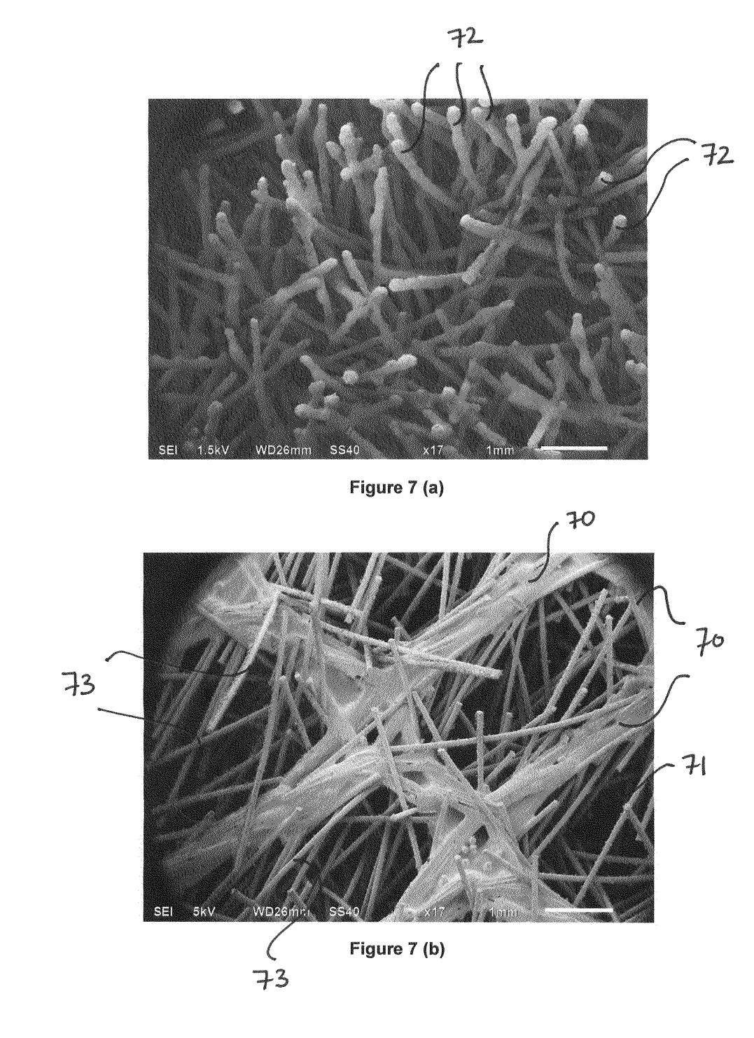

FIGS. 7 (a) and (b) are Scanning Electron Micrographs of the contact surface (a) and the internal surface (b) of an open mesh structure of the present invention with filamentous projections introduced by flocking; and

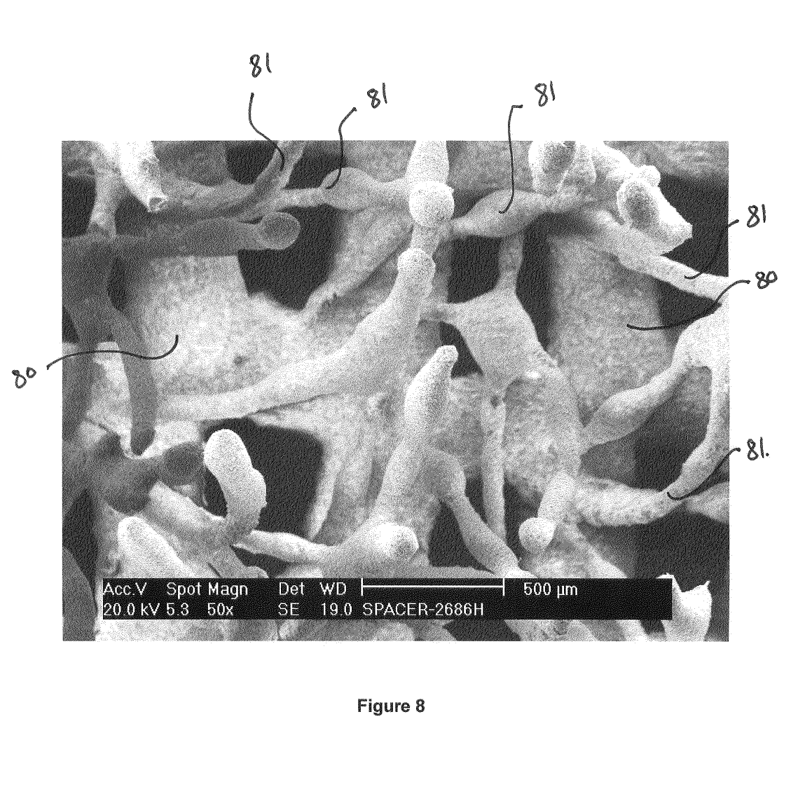

FIG. 8 is a Scanning Electron Micrograph of an open mesh structure of the present invention as prepared via the splitting of a warp knitted spacer fabric.

Referring to FIG. 1, an open mesh pest control material (1) comprises an open mesh net material (2), with a plurality of apertures (3) an insect contact surface (4) and an internal surface (not shown). The contact surface (4) is provided with a plurality of filamentous projections (5) protruding therefrom. A mosquito is shown alighted upon the insect contact surface (4) and in contact with a plurality of filamentous projections (5), which are inhibiting the mosquito from entering or orientating itself to the apertures (3) and making contact with anything located in contact with the internal surface of the open mesh pest control material (1).

Referring to FIG. 2, an open mesh pest control material (1) I shown with essentially the same features as the embodiment of FIG. 1. In addition the filamentous projections (5) comprises a proximal end (7) attached to the contact surface (4) of the open mesh net material (2), and a second distal end (6) The distal end (6) of the filamentous projections is in the form of a barb adapted to penetrate the exocuticle of the insect alighted upon the insect contact surface (4).

Referring to FIG. 3 it can be seen how randomly oriented filamentous projections (20) standing proud from a generally planar insect contact surface (21) function to occlude access to apertures (22) in the contact surface (21) by a probing insect arriving from above the surface. A coating (23) comprising an insecticide is show coating all surfaces of the open mesh pest control material (1) Referring to FIG. 4 it can be seen how the distribution of coating (23) may be restricted and can be located mainly on the surfaces of the filament projections (20) rather than on the underlying open mesh insect contact surface (21).

Referring to FIG. 5 there can be seen droplets of coating material (23) formed on the distal ends (24) of surface proud filamentous projections (20) of a material in accordance with an embodiment of the invention.

Referring to FIG. 6 an open mesh pest control material (60) comprises a knitted fabric base structure (61) defining a plurality of apertures (62) and insect contact surface (63). A plurality of filamentous projections (64) can be seen orientated perpendicular to the plane (X-X) of the material and a plurality of filamentous projections (65) can be seen orientated horizontal to the plane (X-X) of the material, with some (66) projecting across and partially occluding the apertures (63).

Referring to FIGS. 7(a) and (b) an open mesh fabric is illustrated, which has been manufactured by the flocking short cut fibres of 5 mm to a warp knitted mesh fabric that was pre-coated with an acrylic binder, followed by drying. After drying acrylic binder containing diatomaceous earth was applied to the structure by spraying followed by drying and curing. The warp knitted mesh (70) can clearly be seen when viewing the internal surface of the structure in FIG. 7(b) as can the apertures (71). In FIG. 7(a) it can be seen that when the structure is viewed from the contact surface the plurality of filamentous projections (72) with a plurality of orientations partially obscure the apertures (71). When viewed from the internal surface as shown in FIG. 7(b), there is a lower density of filamentous projections (73) protruding from the internal surface of the structure and there are a number of filamentous projections that are located within the apertures (71). Although there is a significant density of filamentous projections bonded to the open mesh structure it has acceptable light transmission and air transmission properties for use as a mosquito net or crop protection net. It can be seen that the acrylic binder materials covers all of the structure and that the filamentous projections have small particles of diatomaceous earth bonded to their surfaces.

Referring to FIG. 8 the contact surface of an open mesh structure (80) is presented, with a plurality of filamentous projections (81). The illustrated structure has been produced by the planar splitting of a warp knitted spacer fabric to produce filament projections. The structure has been oversprayed with an acrylic binder containing diatomaceous earth followed by through air drying and curing. In this example the acrylic coating is applied to all surfaces of the structure.

The invention will now be further illustrated by way of following non limiting examples, which contain technical disclose that may be combined with any of the previously described aspects of the invention.

### EXAMPLE 1

The open mesh structure comprising filamentous projections shown in FIG. 7(a)/(b) was prepared use a flocking method as follows:

A fabric for forming the base open mesh structure was selected with a warp knitted mesh, of weight 30 g/m², with a mesh of 156 holes/inch² and made from 75 denier polyester filament yarn. The flocking adhesive selected was an acrylic binder sprayed onto the fabric mesh to create an adhesive layer with a thickness of 0.1× the flock fibre length. Practically the adhesive should remain in liquid form on the surface of the mesh when the flocking procedure commences. To increase the bonding strength between the flock and the fabric an epoxy adhesive is preferred.

A flocking machine was a standard flocking machine set to operate at 60,000 volts. Up to 100,000 volts may be required to increase the penetration of the fibre on the adhesive layer. The flocking fibre selected was a nylon flock fibre of 2 mm/22dtex, but other fibres of 2 mm/44dtex or 5 mm/44dtex may be used. This was applied to the adhesive treated fabric in the flocking machine.

The flock fibre can be selected from a wide range of materials that are compatible with the flocking process and which produce filamentous projections of the required properties. The fibres may for example be polyesters such as PET, polyamides, polyacrylamides, polyethylene or polyproplylene. The fibre was activated via chemical treatment to aid the flocking process.

After flocking was completed the flocked structure was air dryed for at least 24 hours. In some cases drying can be extended for as long as 72 hours.

A diatomaceous earth coating composition was prepared by mixing the diatomaceous earth with relatively soft water at high shear in a high shear mixer. To this mixture under shear was added an acrylic latex until the mixture was homogeneous. The diatomaceous earth coating composition was applied to the dry flocked structure using a compressed air atomising spray gun at 2-4 bar. After spraying the coated structure was dried and cured in a Stenter oven at 130° C. for 8 minutes to provide the final material.

### EXAMPLE 2

An open mesh structure according to the invention was prepared via a split spacer fabric using the following general methods:

The base fabric, prepared by known methods, was a planar split warp knitted spacer mesh fabric produced from monofilament yarns (PET): 10 mm thickness. The area density of the unslit warp knitted spacer mesh was ca. 280-320 g/m² and the exact weight selected depending on the required aperture size. The surface filaments were selected from 75 dtex or 167dtex textured PET) although other linear densities can be utilised depending on the required area density of the resulting material.

The projection filaments were 0.07 mm PET monofilament. Other dimensions may be selected depending on the stiffness and compression characteristics of the projecting filaments required in the final product after slitting.

The slitting of the spacer fabric takes place in-plane down the centre of the mesh fabric. After slitting the resulting open mesh material with filamentous projections was treated with a coating formulation comprising diatomaceous earth as prepared in Example 1.

This coating composition was applied to the slit structure via use of a compressed air atomising spray gun such as an FB2200 Professional Gravity Feed Spray Gun, with a compressed air supply to the line, controlled regulation between 2-4 bar. The spraying applies the coating formulation to both the projecting filaments and to the underlying mesh of the material. After coating the structures was dried and cured in a Stenter/Oven capable at a temperature within the range between 130-250° C. depending on binder specifications and for 1-10 min.

1. An open mesh material comprising a contact surface, an internal surface, apertures communicating both surfaces and a plurality of filamentous projections protruding from the contact surface and wherein projections at least partly occlude the apertures.

2. A material in the form of an open mesh structure, having a surface with multiple filamentous projections protruding in one or more different orientation directions

3. The material according to claim 1 as a pest control material.

4. The material according to claim 1 wherein the fabric has an area density of about 50 to 350 g/m².

5. The material according to claim 1 wherein the aperture size in the open mesh is from 0.5 mm to 12 mm².

6. The material according to claim 1 which has an air permeability (air flow rate) of >6 m/s @100 Pa.

7. The material according to claim 1 wherein the size of the apertures in the mesh is from 0.5 mm and 10 mm in diameter.

8. The material according to claim 1 wherein the density of apertures is from about 50-1600 apertures/inch.

9. The material according to claim 1 wherein the shape of the apertures is selected from a square-mesh, a triangular-mesh, a rhomboid-mesh, a hexagonal-mesh, and a rectangular-mesh, and combinations thereof.

10. The material according to claim 1 wherein the length of the filamentous projections is from 1.5 mm to 20 mm.

11. The material according to claim 1 wherein the filamentous projections are flexible and/or resilient.

12. The material according to claim 1 wherein the population density of the filamentous projections is from 20 to 150 per cm².

13. The material according to claim 1 wherein the filamentous projections are connected at the contact surface of an underlying open mesh material.

14. The material according to claim 1 wherein the length:diameter ratio of the projections is from about 3 to 150.

15. The material according to claim 1 wherein the apparent overall thickness of the structure to from about 2 to 10 mm.

16. The material according to claim 1 wherein the projections comprise monofilaments, multifilaments, filamentous staple yarns, continuous or multi-filament yarns, flocked filamentous fibres, hot melt adhesive raised from the surface or substantially embossed regions, or combinations thereof.

17. The material according to claim 1 wherein the projections comprise continuous or multi-filament yarns that are firmly connected to the surface of the underlying open mesh fabric.

18. The material according to claim 1 wherein the filamentous projections are oriented at from 1 to 90 degrees relative to the surface of the underlying open mesh fabric.

19. The material according to claim 1 wherein the filamentous projections comprise substantially uniformly cylindrical filaments.

20. The material according to claim 1 wherein the distal tips of the filamentous projections are modified so as to increase their diameter relative to the underlying stem of the filamentous projection.

21. The material according to claim 1 wherein the open mesh structure is based on warp and weft knitting (intermeshed structure), weaving (interlaced structure) knotting or plain net (twist lace) fabric production.

22. The material according claim 1 wherein the open mesh structure is produced by warp knitting.

23. The material according to claim 1 wherein the filamentous projections comprise one or more thermoplastic materials.

24. The material according to claim 1 wherein at least a proportion of the filamentous projections comprise a coating of an insecticidal material.

25. The material according to claim 24 wherein the insecticidal material is adhered to the filamentous projections and/or the open mesh using a binder or an adhesive.

26. The use of a material according to claim 1 in the manufacture of a pest control material.

27. The method of pest control, which comprises substantially surrounding a potential host with a pest control material according to claim 1.

28. The method of preparation of a material according to claim 1; which method comprises slitting and separating a warp knitted spacer fabric comprised of two discrete mesh fabrics layers interconnected by crossing filaments longitudinally between each of the mesh fabric layers.

29. The method of preparation according to claim 28 which comprises slitting a warp knitted spacer fabric comprised of two discrete mesh fabrics layers interconnected by crossing filaments between each of the mesh fabric layers to produce two separate and discrete open mesh structures with filamentous projections.

30. The method according to claim 28 which includes coating at least the distal tips of the projections with an insecticidal material.

31. The method according to claim 28 wherein localised heat treatment is applied at the distal tips of the projections.

32. The method of preparation of a material according to claim 1; which method comprises applying a filamentous material to an open mesh material via a flocking process.

33. A material, use or method substantially as hereinbefore described with reference to the accompanying examples and figures.

34. A material having a contact surface through which a plurality of apertures of a predetermined size are formed, the material intended to resist penetration by an insect having a predetermined frontal cross-sectional size, the material wherein: the apertures being formed to have a size larger than the predetermined frontal cross-sectional size; and a plurality of projections standing proud from the contact surface to at least partially occlude access to the apertures, the projections effective to block the passage of the insect in spite of the apertures being large enough to otherwise allow passage of the insect there through.

35. The material according to claim 34 and intended to resist penetration by a plurality of types of insects having a corresponding plurality of predetermined frontal cross-sectional sizes, the material further wherein: the apertures being formed to have a size small enough to block the passage of a first of the types of insects and large enough to permit the passage of a second of the types of insects; and the plurality of projections occluding access to the apertures to a degree effective to block the passage of the second of the types of insects in spite of the apertures being large enough to allow passage.

36. The material according to claim 34, wherein the structure comprises an insecticidal material and the insecticidal material comprises a diatomaceous earth material.

37. The material according to claim 34, further wherein at least some of the projections having a bulbous tip on the distal ends of the respective projections.

38. The material according to claim 34 further wherein the apertures being formed to have a size at least 20% larger by area than the predetermined frontal cross-sectional size of the insect.

39. The material according to claim 38 further wherein the apertures being formed to have a size at least 50% larger by area than the predetermined frontal cross-sectional size of the insect.

40. The material according to claim 38 further wherein the apertures being formed to have a size at least twice as large by area as the predetermined frontal cross-sectional size of the insect.

41. An open mesh material wherein: a contact surface and an internal surface having a plurality of apertures therein communicating both surfaces that collectively define an actual open area of the material; and a plurality of filamentous projections standing proud from the contact surface, the plurality of projections effective to create an apparent open area of the material that is less than 80% of the actual open area of the material when viewed from above.

42. The material according to claim 41 further wherein the apparent open area being less than 30% of an entire surface area of the material when viewed from above.

43. The material according to claim 41 which comprises a plurality of filamentous projections standing proud from both the contact and internal surfaces of the open mesh material.

44. The material as claimed in claim 43, further comprising a plurality of filamentous projections in standing proud form the surfaces if the apertures.
